(19) United States
(12) Patent Application Publication
(10) Pub. No.: US 2013/0232428 A1
(43) Pub. Date: Sep. 5, 2013

(54) METHOD AND APPARATUS FOR SHARING PERSONALIZED HOMEPAGE WITH A PLURALITY OF USERS

(71) Applicant: PERION NETWORK LTD., Tel Aviv (IL)

(72) Inventors: Boaz Levin, Netanya (IL); Rajiv Jain, Monte Sereno, CA (US); Jennifer De Las Casas Shemer, Tel-Aviv (IL)

(73) Assignee: PERION NETWORK LTD., Tel Aviv (IL)

(21) Appl. No.: 13/774,674

(22) Filed: Feb. 22, 2013

(30) Foreign Application Priority Data
Feb. 23, 2012 (IL) 218288

(51) Int. Cl. H04L 29/08

(52) U.S. Cl. CPC H04L 67/02
USPC 715/760

(57) ABSTRACT

A method is provided for sharing a personalized homepage with a plurality of users, the method comprising: providing a personalized homepage created by a first user from among the plurality of users, the personalized homepage comprising personal content; upon storing the personalized homepage, sending a first indication to all other users from among the plurality of users, wherein that first indication relates to the creation of said personalized homepage; receiving from at least one second user from among the plurality of users, one or more comments associated with at least some of the personal content comprised in the first user's personalized homepage; and providing the first user with the one or more comments received from the at least one second user.

### CROSS-REFERENCE TO RELATED APPLICATIONS

This application claims priority of Israel Patent 10 Application No. 218288, filed Feb. 23, 2012, the disclosure of which is incorporated by reference herein in its entirety.

### TECHNICAL FIELD The present disclosure generally relates to methods for enhancing users' online experience, and more particularly for incorporating social elements into websites.

### BACKGROUND

In the recent years, along with the spreading of social network applications such as Facebook™, LinkedIn™, Google+®, MySpace® etc. around the globe, the Internet has been evolving rather dramatically and has become more and more social orientated. Many types of websites, traditionally non-social ones, started to incorporate social elements in their web sites. News websites such as The New York Times and The Washington Post enable users to recommend articles that they choose to their friends; E-commerce websites like Amazon™ and Groupon™ provide some mechanism of payback for users that publish their recent purchases, and more.

A homepage, also known as a start page, is a web page that is automatically loaded when a web browser (e.g. Chrome™, Firefox™, Explorer™ or Safari™) is activated or when the browser's “home” button is pressed. The user may change the default browser's homepage by specifying a URL of the page that he wishes to be loaded, or alternatively by re-loading recent web page browsed. Homepages usually contain an input box associated with a search engine (e.g. Google™, Bing™), some more advanced homepages may include news, weather forecasts, games, web gadgets, and even aggregate information such as web links and RSS feeds.

There are several known methods in the art for creating a customizable homepage, among which for example are: TW 201113728 which discloses a personalized homepage generation system capable of generating webpage content according to the user preference, selecting a template, recovering a pre-shutdown screen upon login, and displaying dynamic webpage data according to settings, user server verifies the user data and records the user's homepage. A user preference server may record the user's webpage browsing history and analyze the user's preference data and a webpage editing server provides various types of webpage templates. Once the user connects to the system, he may browse at favorite webpage data, and may select a personalized webpage template.

U.S. 2009077495 discloses a method of automatically creating a personalized homepage in which infers one or more categories of interest from previous user activities in a different but related web service product, instead of expressly asking the user to input his/her areas of interest.

Other customizable homepage known in the market are Google™'s customizable homepage called “iGoogle™” and Yahoo™'s customizable homepage called “My Yahoo™”. However, all of the services provided by the prior art solutions, do not provide a comprehensive enough social experience to the users, in a manner provided by the present invention.

### SUMMARY OF THE DISCLOSURE

The disclosure may be summarized by referring to the appended claims.

It is an object of the present invention to provide methods and systems for enabling a user to create a personalized homepage and share it with other users.

It is another object of the present invention to provide methods and systems for enabling users to comment on other users' homepage.

Other objects of the invention will become apparent as the description of the invention proceeds.

According to one embodiment of the invention a method is provided a method for sharing a personalized homepage with a plurality of users. The method comprising:
providing a personalized homepage created by a first user out of the plurality of users, such that the personalized homepage comprising personal content;
upon storing the personalized homepage, sending to all other of the plurality of users, a first indication which relates to the creation of the personalized homepage. These other users (out of the plurality of users) may relate to the first users for example as “friends”, “followers”, or under any other suitable relationship. In addition or in the alternative, the other of the first plurality of users may be other users who had signed in as users of the service;
receiving from at least one second user (out of the plurality of users), one or more comments associated with at least some of the personal content comprised in the first user's personalized homepage; and
providing the first user with the one or more comments received from the at least one second user.

According to another embodiment, the method provided further comprises a step wherein upon affecting a modification at the personalized homepage, a second indication is generated to be forwarded to all other users, wherein the second indication relates to the modification affected in the personalized homepage.

By still another embodiment, the method further comprises a step of providing more than one personalized homepage created by the first user, wherein each of the more than one personalized homepage comprises personal content, and wherein upon storing the more than one personalized homepage, enabling the first user to select one out of the more than one personalized homepages, to be used.

In accordance with another embodiment, the personalized homepage comprises personal content stored at a server hosting at least one other website at which the first user is registered.

By yet another embodiment, prior to sending the first indication, the method further comprises a step of receiving a list of users generated by or in association with the first user, wherein this list of users identifies other users to whom the first indication would be sent (e.g. those who will be qualified to share the personalized homepage), and preferably their contact details.

According to another aspect, there is provided in a communication network, a server operative to enable sharing a personalized homepage with a plurality of users which comprises:
an input interface operative to receive a digital representation of a personalized homepage created by a first user out of the plurality of users, wherein the personalized homepage comprises personal content;
a storage operative to store the digital representation of the personalized homepage received;
an output interface operative to forward a first indication which relates to the creation of the personalized homepage, wherein the first indication is destined to all other users belonging to that plurality of users;
wherein the input interface is further adapted to receive from at least one second user out of the plurality of users, one or more comments associated with at least some of the personal content comprised in the first user's personalized homepage; and
wherein the output interface is further adapted to forward towards the first user the one or more comments received from the at least one second user.

According to another embodiment of this aspect, the output interface is further operative to forward a second indication towards all others of the plurality of users, and wherein the second indication relates to a modification affected in the personalized homepage.

By yet another embodiment, the storage is adapted to store more than one personalized homepage created by the first user, wherein each of the more than one personalized homepage comprises personal content, and wherein the server is further adapted to enable the first user to select which one out of the more than one stored personalized homepages, would be used.

According to still another embodiment, the server is further adapted to host at least one other website at which the first user is registered.

According to another aspect there is provided a non-transitory computer-readable storage media storing one or more sequences of instructions which when executed cause one or more processors to perform:
receiving a personalized homepage created by a first user out of a plurality of users, wherein the personalized homepage comprises personal content;
storing the personalized homepage received (a new personalized homepage or a modified one);
sending to all other of the plurality of users, a first indication indicating that the personalized homepage has been stored;
receiving from at least one second user out of the plurality of users, one or more comments associated with at least some of the personal content comprised in the first user's personalized homepage; and
sending to the first user the one or more comments received from the at least one second user.

By yet another embodiment, the non-transitory computer-readable storage media further comprises instructions which when executed cause the one or more processors also to perform:
receiving a modification associated with the personalized homepage; and
generating a second indication to be forwarded to users belonging to the plurality of users, wherein the second indication relates to the modification affected in the personalized homepage.

### GLOSSARY

Before describing further specific details of the present invention, the following section is provided for elaborating on various terms used herein and throughout the specification and claims. The glossary is intended to provide the reader with a general understanding of the intended meanings of the terms, but is not intended to convey the entire scope associated with each respective term. Rather, the glossary is intended to supplement the rest of the specification by more accurately explaining the terms used.

Comment—a response message that relates to at least part of the personal content comprised in a user's personalized homepage. The comment may be conveyed to the user who created the personalized homepage and/or to other users (e.g. a public comment) and/or to a managing entity. The response massage is not limited to being a text massage, and may comprise internet link, images, video clips, and the like.
Creating a personalized homepage—a set of actions associated with forming a personal homepage. The set of actions may comprise one or more of the following: uploading personal content to the server, importing personal content from other websites (e.g. personal blog, Dropbox™, Picasa™, Facebook™ etc.), selecting which of the personal content would be incorporated in the personalized homepage, selecting size and location of each of the personal content to be presented at the personalized homepage, selecting background of the homepage, selecting a list of users with whom the personalized homepage would be shared, etc. One or more of the actions described above may be carried out at the user's own computer and/or at an online virtual environment, or be uploaded at a suitable time.
Homepage—a web page or local file that automatically loads when a web browser starts or when the browser's “home” button is pressed.
Indication—a message addressed to one or more users which denotes either a creation of a personalized homepage or a modification thereof. The indication comprises information that relates to the identity of the user whose homepage was created or modified, and may be delivered along any medium known in the art per se e.g. an SMS, an e-mail, a notification in Facebook, a notice at the homepage, etc.
Personal content—a work which may be represented in a digital form and selected by the user. Examples of personal content are: posts, stories, HTML5 code, photos, songs, video streams and the like.
Personalized homepage—a homepage that comprises a user's personal content and wherein the user decisions affect the appearance of the homepage.
Sharing a personalized homepage—providing each of a plurality of users with a copy or a representation of the personalized homepage and receiving from at least one user from among the plurality of users, a comment associated with at least some of the personal content comprised in the personalized homepage.

### BRIEF DESCRIPTION OF THE DRAWINGS

For a more complete understanding of the present invention, reference is now made to the following detailed description taken in conjunction with the accompanying drawings wherein:

FIGS. 1A and 1B—are schematic diagrams demonstrating relations between a user and a server hosting the user's homepage:

FIG. 1A demonstrates the relations between a user and a server hosting the user's homepage according to prior art solutions;

FIG. 1B demonstrates the relations between a user, the user's server hosting the homepage according, and other users according to an embodiment of the present invention;

FIG. 2 is a flow chart which exemplifies some embodiments carried out according to the method provided by the present invention; and

FIG. 3 is a flow chart illustrating an embodiment of carrying out part of the method exemplified in FIG. 2, thereby enabling the user to share his/her personalized homepage with others.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

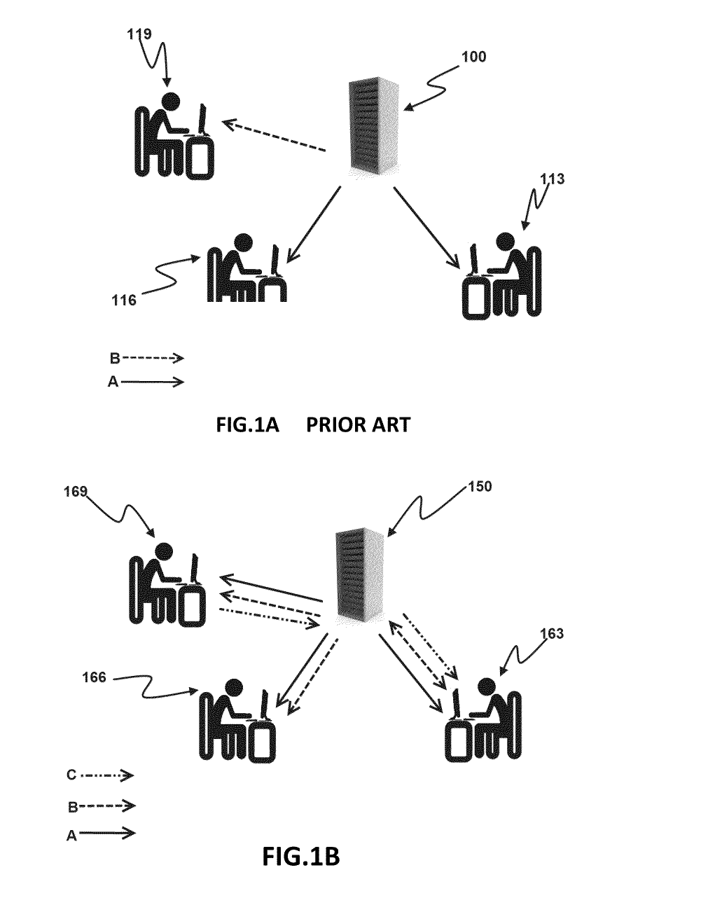

Let us first consider the schematic diagram of FIG. 1A which demonstrates the relations between a user and the server hosting his homepage according to prior art solutions. In FIG. 1A, one server is shown, server 100, which represents one or more servers that host the homepages that are used by three users 113, 116, and 119.

There are two types of connections extending between the server and the user, and these connections are demonstrated by arrows. One type of connection is represented by solid arrows (A) extending between server 100 and users 113 and 116. The other type of connection is represented by a dash arrow (B) and extends between server 100 and user 119. The arrows represent the appearance of the homepage and/or content presented at the homepage and/or preferences or setting of the homepage. In the simple case of the prior art solution, users 113 and 116 use the website www.google.com as their homepage. In this case, Google™ is the entity who decides the appearance of the user's homepage, e.g. while determining whether to incorporate advertisements in the homepage or not. Google may also decide to change its logo (also known as Doodle) once in a while. A somewhat more advanced scenario, still found in prior art solutions, is represented by dash arrow (B). According to this case, user 119 may choose to change some of the content, for example by using the iGoogle application or by selecting a certain picture to serve as a background. Nevertheless, even in this advanced scenario once user 119 has set his homepage, all of the content that is included in his homepage is originated from the homepage server (either from his own database or by retrieving information from databases hosted at other servers).

Relations that exist between a user, the server hosting the user's homepage and other users, according to an embodiment of the present invention, are demonstrated in FIG. 1B. As in FIG. 1A, also in FIG. 1B one server, 150, is used to represent one or more servers that host the homepages which are used by three users 163, 166, and 169. However, in this example there are three types of connections illustrated. The first type is illustrated by a solid arrow (A) and extends between server 150 and users 163, 166 and 169. The second type is illustrated by arrow (B) and extends also between server 150 and users 163, 166 and 169, whereas a third type of connection is illustrated by arrow (C) and extends between server 150 and users 163 and 169. Each type of connection represents a connection for delivering content originated from a different source:
Type “A” arrow represents delivering content originated from the server hosting the homepage where the content may be delivered to each one of the users of the system. Examples for such content may be: a Logo, the homepage theme, advertisement etc. The content delivered to the various users does not necessarily need to be identical, and according to one embodiment it is based on selection(s) made by the user (similar the scenario represented by the dash arrow in FIG. 1A)
Arrow of the type “B” represents delivering of content originated from user 163 to be published at his homepage. In this case some of the content is delivered to users 166 and 169. Examples for such content may be: posts, links, text, HTML5 code, images, songs, video streams and the like. According to one embodiment user 163 may decide whether his homepage (or specific content from his homepage) is to be shared with all the users in the system. In the alternative user 163 may decide that his homepage is to be shared with one or more specific users of the system, or by another alternative, not to be shared with anyone. In the example demonstrated in FIG. 1B, users 166 and 169 do not share their homepage with other users.
Arrow of the type “C” represents delivering of content originated from user 169 to be published on user 163 homepage. The content associated with arrow C may be for example in response to content that was posted by user 169 on his homepage, e.g. Alice (user 163) uploaded a photo to her homepage, shared it with Bob (user 169) and in response, Bob wrote a comment on the photo which is published on Alice homepage. Examples for such content may be: posts, links, text, HTML5 code, images, video streams and more. In the example illustrated in FIG. 1B, the content represented by connection C is not shared with user 166.

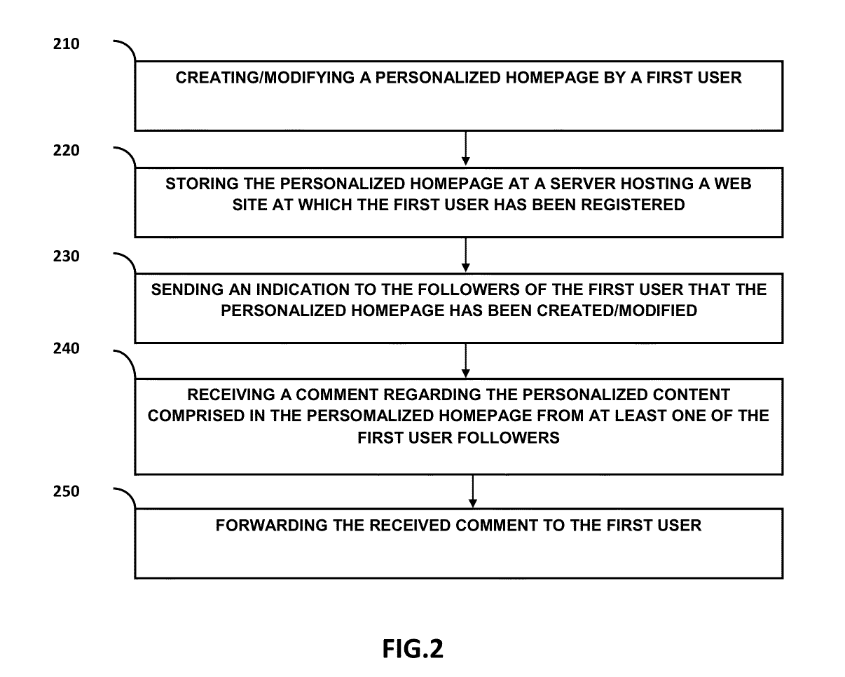

FIG. 2 illustrates a flow chart which exemplifies some embodiments carried out according to the method of the present invention. Upon creating or modifying a personalized homepage that comprises personal content by a first user (step 210), the personalized homepage is stored at a server hosting the web site (step 220). A first indication is initiated for the followers of the first user, wherein that first indication relates to the creation/modification of the personalized homepage and sent to the user's followers (step 230). Next, one or more comments are received from the first user follower(s), which concern the personal content comprised in the personalized homepage (step 240) are forwarded by the initiators of the comment. For example, if a picture has been placed by the first user at the personalized homepage as part of his/her personal content, comments by one or more of the other users (the followers) may relate to that picture. The comment is then provided to that first user (step 250) who may act accordingly (e.g. send a reply, modify personal content, etc).

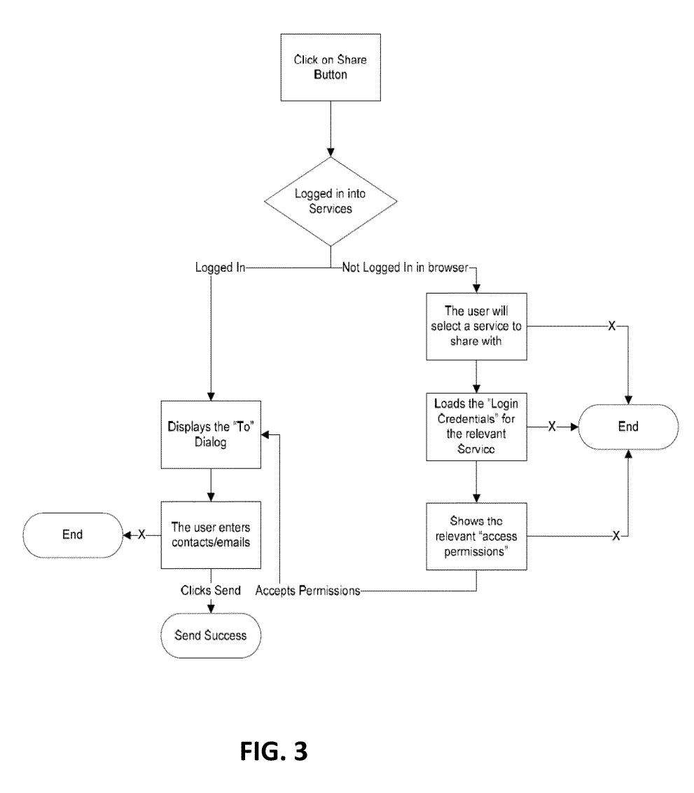

FIG. 3 is a flow chart illustrating an embodiment of carrying out part of the method exemplified above, in order to enable a user to share his/her personalized homepage with others.

When a user decides to share his personalized homepage with other users, at first (step 310) he/she clicks on the button “SHARE”, and then the application determines whether that user has already logged to “SERVICES” (step 320). If the application determines that the user has indeed already logged to “SERVICES”, it displays a “TO” dialog box (step 330) which enables the user to enter details of users with whom the homepage could be shared. The user enters the contact details (e.g. e-mail address, telephone number, user name, etc.) of the users with whom he/she wishes to share his/her personalized homepage (step 340) and will receive an indication once the contact details have been successfully stored (step 350) or otherwise the session will be terminated (step 360). However, if the user is not logged in, the user selects a service that he/she wishes to share with other users (step 370). He would then load/enter his/her “Login Credentials” (e.g. username and password) for the relevant service (step 380) and the relevant “access permissions” will be displayed for the user (step 390). Next, once the permissions are accepted, the application will display the “TO” dialog box as in step 330, and will proceed from the stage onward as described above.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for sharing a personalized homepage with a plurality of users, the method comprising:
providing a personalized homepage created by a first user from among said plurality of users, said personalized homepage comprising personal content;
upon storing said personalized homepage, sending a first indication to all other users of said plurality of users, wherein said first indication relates to the creation of said personalized homepage;
receiving from at least one second user from among said plurality of users, one or more comments associated with at least some of the personal content comprised in said first user's personalized homepage; and
providing said first user with the one or more comments received from said at least one second user.

2. The method according to claim 1, further comprising a step wherein upon modifying said personalized homepage, generating a second indication to be forwarded to all other of said plurality of users, wherein said second indication relates to the modification affected in said personalized homepage.

3. The method according to claim 1, further comprising a step of providing more than one personalized homepage created by said first user, wherein each of said more than one personalized homepage comprises personal content, and wherein upon storing said more than one personalized homepage, enabling the first user to select one out of the more than one personalized homepages, to be used.

4. The method according to claim 1, wherein the personalized homepage comprises personal content stored at a server hosting at least one other website in which the first user is registered.

5. The method according to claim 1, wherein prior to sending said first indication, receiving a list of users generated by or in association with said first user, wherein said list of users identifies other users to whom the first indication will be sent.

6. In a communication network, a server operative to enable sharing a personalized homepage with a plurality of users, the server comprising:
an input interface operative to receive a digital representation of a personalized homepage created by a first user out of said plurality of users, wherein said personalized homepage comprises personal content;
a storage operative to store the digital representation of the personalized homepage received;
an output interface operative to forward a first indication which relates to the creation of said personalized homepage, wherein said first indication is destined to all other users from among said plurality of users;
wherein said input interface is further adapted to receive from at least one second user out of said plurality of users, one or more comments associated with at least some of the personal content comprised in said first user's personalized homepage;
and wherein said output interface is further adapted to forward towards said first user the one or more comments received from said at least one second user.

7. The server according to claim 6, wherein said output interface is further operative to forward a second indication towards said all other of said plurality of users, and wherein said second indication relates to a modification affected in said personalized homepage.

8. The server according to claim 6, wherein said storage is adapted to store more than one personalized homepage created by said first user, wherein each of said more than one personalized homepage comprises personal content, and wherein said server is further adapted to enable the first user to select which one of the more than one stored personalized homepages, would be used.

9. The server according to claim 6, wherein said server is further adapted to host at least one other website at which the first user is registered.

10. A computer program product encoding a computer program stored on a non-transitory computer readable storage media for executing a set of instructions, for carrying out by one or more processors a method for sharing a personalized homepage with a plurality of users, the method comprising:
receiving a personalized homepage created by a first user out of a plurality of users, wherein said personalized homepage comprises personal content;
storing the personalized homepage received;
sending to all other of said plurality of users, a first indication which relates to the fact that said personalized homepage has been stored;
receiving from at least one second user out of said plurality of users, one or more comments associated with at least some of the personal content comprised in said first user's personalized homepage; and
sending to said first user the one or more comments received from said at least one second user.

11. The computer program product according to claim 10, further comprising instructions which when executed cause the one or more processors also to perform:
receiving a modification associated with said personalized homepage; and
generating a second indication to be forwarded to user belonging to said plurality of users, wherein said second indication relates to the modification affected in said personalized homepage.
